(19) United States
(12) Patent Application Publication
(10) Pub. No.: US 2008/0021598 A1
(43) Pub. Date: Jan. 24, 2008

(54) Control System For A Vehicle

(75) Inventors: Rainer Daude, Unterschleissheim (DE); Guenter Metsch, Moeglingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Muenchen (DE)

(21) Appl. No.: 10/584,463

(22) PCT Filed: Dec. 16, 2004
(86) PCT No.: PCT/EP04/14321

§ 371 Date: Jun. 6, 2007

(30) Foreign Application Priority Data
Dec. 23, 2003 (DE) 103 60 656.4

(51) Int. Cl. G06F 17/00

(52) U.S. Cl. 701/1

(57) ABSTRACT

An operating system for a vehicle, including a display screen containing a plurality of representation regions for representing inputs of a menu structure with a plurality of levels, a manual actuating means for selecting and/or activating at least one input in a current level of the menu structure, and voice control means for a redundant selection and/or activation of at least one input from the menu structure. The voice control means evaluate the current menu level and/or an active representation region and/or a current cursor position, and determine an operating purpose according to the evaluation. Once the voice control means have been activated, they start at least one voice dialogue associated with the determined operating purpose for selecting and/or activating at least one input from the menu structure.

The invention relates to a control system for a vehicle as claimed in the precharacterizing clause of patent claim 1.

Use is increasingly being made of multimedia control systems in modern vehicles. The command system in the Mercedes-Benz S-Class is mentioned here by way of example.

DE 197 52 056 A1 describes a control system for a motor vehicle. In this control system, two display areas are displayed on a screen display in a menu structure having a plurality of menu levels. A first display area is arranged in the form of a frame around the second display area. On a first menu level, eight fields having entries which correspond to executable applications and are arranged vertically and horizontally are displayed in the first display area. An entry is selected by pushing or tilting the manual operating means with a plurality of adjustment degrees of freedom in the direction of the position of the corresponding entry in the first display area. Pressing the manual operating means activates a selected entry. Following activation, a plurality of entries which are arranged vertically and are assigned to the activated entry on the first menu level are displayed in the second display area on a second menu level. The entries which are displayed in the second display area are selected by rotating the manual operating means and are activated by pressing the manual operating means. The activated second display area and the second menu level are left by pushing or tilting the manual operating means in the direction of a position of one of the entries in the first display area. The control system is then in the first display area on the first menu level again.

EP 1 342 605 A1 describes a control system for a motor vehicle, said system having a screen display, a manual operating means with a plurality of adjustment degrees of freedom and voice control means. The screen display comprises a plurality of display areas for displaying entries in a menu structure having a plurality of menu levels, the entries in the menu structure being able to be selected and/or activated using the manual operating means and/or the voice control means. The entries in the menu structure which are displayed on the screen display simultaneously form the keywords which can be currently input for voice-controlled menu navigation.

U.S. Pat. No. 4,827,520 describes a control system for a motor vehicle, said system having a screen display, a plurality of manual operating means, which are arranged in the area surrounding the screen display, and voice control means. The screen display comprises a plurality of display areas for displaying entries in a menu structure having a plurality of menu levels, the entries in the menu structure being able to be selected and/or activated using the manual operating means and/or the voice control means. The entries in the menu structure which are displayed on the screen display or on the manual operating means simultaneously form the keywords which can be currently input for voice-controlled menu navigation.

U.S. Pat. No. 4,797,924 describes a control system for a motor vehicle, said system having a screen display, a plurality of manual operating means and voice control means. The various vehicle components such as a telephone system, a radio etc. can be controlled using both the manual operating means and the voice control means. For the purpose of voice control, the terms which can be input are organized hierarchically in a command structure having a plurality of command levels, only terms on a current command level being able to be input and being understood and executed by the voice control means.

It is an object of the invention to specify an improved control system for a vehicle, which system enables intuitive voice control and improves control convenience.

The invention achieves this object by providing a control system for a vehicle having the features of patent claim 1.

Advantageous embodiments and developments of the invention are specified in the dependent claims.

The invention is based on the idea that voice control means determine an intended control operation by the user on the basis of a current menu level and/or an active display area and/or a current cursor position and, after they have been activated, start at least one voice dialog, which is associated with the intended control operation determined, for the purpose of selecting and/or activating one or more entries in the menu structure.

In one advantageous refinement of the inventive control system, the voice control means continuously determine the current menu level and/or the active display area and/or the current cursor position in the menu structure. The voice control means receive the information regarding the application which is currently activated and/or the display area which is currently active and/or the current cursor position in the menu structure from an evaluation and control unit, for example. As a result, the voice control means know the current state and the current position within the menu structure although entries in the menu structure can also be selected using a manual operating means. As a result of the inventive control system, manual control and voice control are thus linked in an optimized manner and a universal control concept over all of the input and/or output channels is achieved.

In one refinement of the invention, the voice control means request a particular voice input in a first voice dialog if the voice control means have detected that the current menu position and/or cursor position suggest(s) a particular intended control operation and thus a particular voice dialog.

After requesting the voice input, the voice control means expect the particular voice input in the first voice dialog.

In another refinement of the invention, the voice control means output possible keywords for selection in a second voice dialog if the voice control means have detected that the current menu position and/or cursor position suggest(s) a plurality of possible voice dialogs, i.e. it is not clear which control action the user would like to carry out.

After requesting the selection of one of the keywords, the voice control means expect the voice input of one of the keywords, which have been output, in the second voice dialog.

In one advantageous development of the inventive control system, provision is made of a third voice dialog comprising any desired sequence of the first and/or second voice dialog, i.e. any desired number of voice dialogs of the first or second type may be strung together. This advantageously makes it possible to successively carry out selection steps, which build on one another, in the form of voice dialogs.

In another refinement, the voice control means are activated for the duration of the current voice dialog, with the result that the user does not have to reactivate the voice control means during the voice dialog.

In another refinement, the representation of the menu structure on the screen display can be updated in accordance with the voice dialog steps, i.e. selected application menus, function menus, submenus and/or corresponding display areas are opened, activated and displayed, for example. This makes it possible for the user to change between voice input and manual input as desired and, if necessary, to monitor the progress of the selection process on the screen display.

The inventive control system implements a standard control concept for voice control and manual control, which enables the user to control the menu structure having a plurality of menu levels using voice control means and/or the manual operating means without having to remember a voice command or having to read the possible voice commands from the screen display. As a result of it being possible to change between the input channels,. i.e. between voice input and manual input, intuitive control and control convenience are improved. In addition, faster control is possible as a result of dialog steps being eliminated.

Advantageous embodiments of the invention are described below and are illustrated in the drawings, in which:

FIG. 1 shows a block diagram of a control system for a motor vehicle;

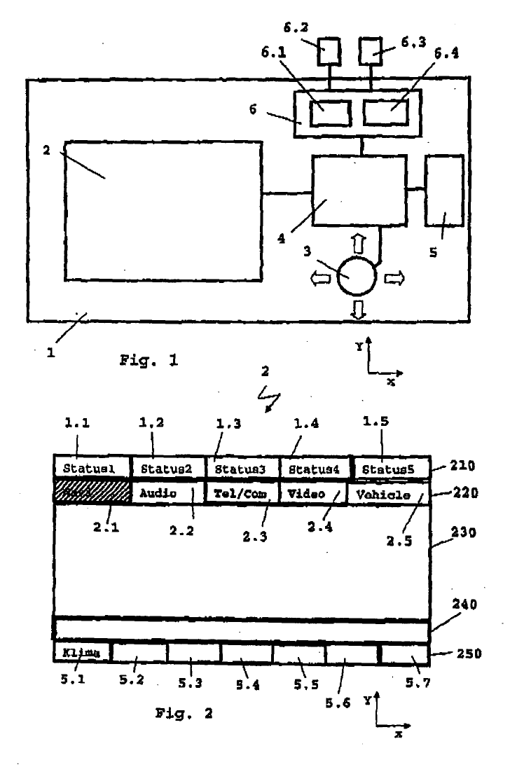

FIG. 2 shows a diagrammatic illustration of a screen display as shown in FIG. 1 on a first menu level;

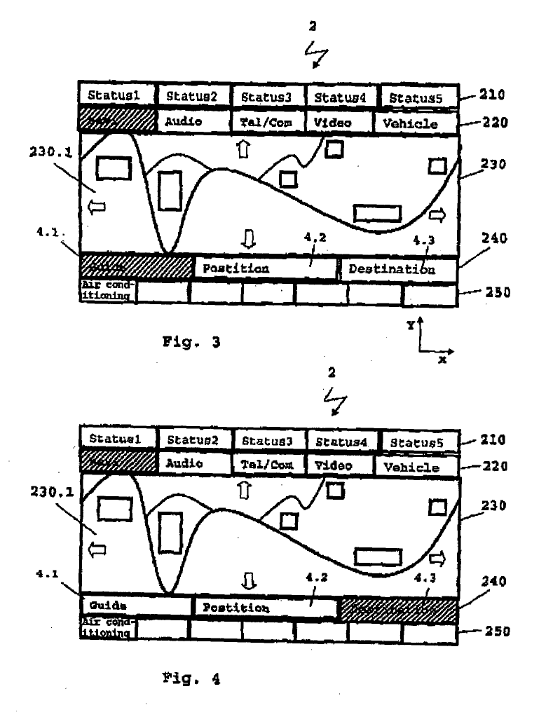

FIG. 3 shows a diagrammatic illustration of the screen display as shown in FIG. 1 on a second menu level;

FIG. 4 shows a diagrammatic illustration of the screen display as shown in FIG. 1 on the second menu level;

FIG. 5 shows a diagrammatic illustration of the screen display as shown in FIG. 1 on a third menu level; and

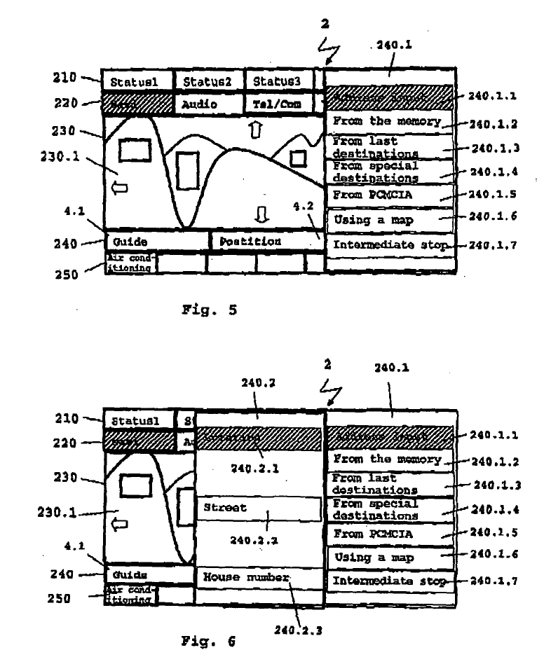

FIG. 6 shows a diagrammatic illustration of the screen display as shown in FIG. 1 on a fourth menu level.

As can be seen in FIG. 1, the control system 1 for a motor vehicle comprises a screen display 2, a manual operating means 3, a control and evaluation unit 4, voice control means 6 and a plurality of vehicle systems such as a navigation system, a heating and air conditioning system, a mobile telephone, a video system, an audio system etc. which are illustrated together as an element 5. The vehicle systems transmit signals to the evaluation and control unit 4, the control and evaluation unit 4 using said signals to determine current system states. All applications and/or functions and/or subfunctions and/or options and/or status displays on various menu levels of a menu structure are controlled using the manual operating means 3. In addition, prescribed applications and/or functions and/or subfunctions and/or options and/or status displays on various menu levels of the menu structure may be controlled, in a manner that is redundant to control using the manual operating means 3, by means of an appropriate voice input using the voice control means 6.

The voice control means 6 comprise, for example, voice input means 6.2, for example at least one microphone, a voice recognition unit 6.1, voice output means 6.3, for example at least one loudspeaker, and at least one memory unit 6.4.

The manual operating means 3 has seven adjustment degrees of freedom for selecting and/or activating entries which are displayed in an active display area. Said operating means can be pushed in four directions as shown by the arrows in FIG. 1, i.e. in a positive x-direction, a negative x-direction, a positive y-direction or a negative y-direction. In addition, it can be rotated clockwise or counterclockwise about a z-axis, which is not illustrated and is perpendicular to the plane of the drawing, and can be pressed in the direction of the negative z-direction, i.e. into the plane of the drawing.

Rotating the manual operating means 3 clockwise moves a cursor on the screen display 2 to the right or downward on the basis of a horizontal or vertical orientation of the entries which are displayed on the screen display 2, and rotating said operating means counterclockwise moves the cursor to the left or upward, Pushing the manual operating means 3 upward in FIG. 1, i.e. forward in the direction of the windshield, i.e. in the positive y-direction, moves the cursor on the screen display 2 upward, and pushing said operating means downward in FIG. 1, i.e. backward, in the negative y-direction, moves the cursor on the screen display 2 downward. Pushing said operating means to the right, i.e. in the positive x-direction, moves the cursor on the screen display 2 to the right, and pushing said operating means to the left, i.e. in the negative x-direction, moves the cursor to the left.

An entry which is displayed on the screen display 2 is selected and/or activated by pushing or rotating the manual operating means 3. The manual operating means 3 may be rotated about the z-axis in a manner that is redundant to vertically pushing said operating means along an axis, i.e. in the y-direction, or to horizontally pushing said operating means along an axis, i.e. in the x-direction. In this case, the pushing direction for selecting an entry corresponds to the orientation of the entries which are displayed in the active display area. The pushing direction which is respectively orthogonal to the pushing direction for selection results in the active display area being left. In addition, it may be necessary to press the manual operating means 3 in order to activate a selected entry.

In a manner which is redundant to selecting and/or activating entries in the menu structure using the manual operating means 3, the menu structure which is displayed on the screen display can be controlled by means of a voice input of keywords. The entries which are displayed on the screen display 2 and can be input by voice, may have an identifier which is in the form of a special optical representation, for example, and can be achieved using a different color and/or a different intensity and/or a different size and/or a different shape. This is illustrated using bold type in FIGS. 2 to 6. In addition, the entries 1.1 to 5.7 which are displayed on the screen display may also be stored as possible keywords in the memory 6.4 of the voice recognition means 6. In the exemplary embodiment illustrated, a PTT button (Push-To-Talk button) which is preferably arranged within reach of the user, for example on the steering wheel, is manually operated in order to activate the voice control means 6. The function of the PTT button may also be assumed by the manual operating means 6.

As can be seen in FIG. 2, the screen display 2 comprises, on a first menu level, a graphical basic structure of five horizontal display areas 210 to 250 which are arranged vertically. This graphical basic structure is constant over the plurality of various menu levels in the menu structure. The screen display 2 is, for example, in the form of an eight inch screen having an aspect ratio of 15:9.

The graphical basic structure of the display area 230 can be varied over the plurality of various menu levels in the menu structure on the basis of an activated application and/or function and/or subfunction and/or option and/or status display, i.e. the graphical configuration of this central display area 230 may be very different.

One or more horizontally arranged entries 1.1 to 5.7 may be respectively displayed in the four display areas 210, 220, 240 and 250. By way of example, the display areas 210, 220, 240 and 250 in FIG. 2 each comprise a different number of entries on the first menu level. The first display area 210 thus comprises five entries 1.1 to 1.5, the second display area 220 comprises five entries 2.1 to 2.5, the fourth display area does not comprise an entry and the fifth display area comprises seven entries 5.1 to 5.7. In FIG. 2, the second display area 220 has been activated and the hatched entry 2.1 (navi) has been selected. The hatched illustration is intended to indicate that the cursor is on the entry 2.1.

The entries 1.1 to 5.7 in the display areas 210 to 250 which are displayed on the screen display 2 may be arranged according to the importance of their contents or the frequency with which they are used.

The diagrammatic illustration of the screen display 2 in FIGS. 2 to 6 has been adapted to control for a motor vehicle using special entries. As can be seen in FIG. 2, the first display area 210 is in the form of a status line which displays various status displays 1.1 to 1.5 from different applications. The main function of the status line is to display important current system states which are determined by the control and evaluation unit 4 on the basis of signals from the vehicle systems 5. In the exemplary embodiment illustrated, the entries or status displays 1.1 to 1.5 can be selected and activated using only the manual operating means 3. In order to determine the current system states, the signals from the navigation system with a position-finding unit, from the heating and air conditioning system, from the mobile telephone, from the video system, from the audio system etc. are evaluated, for example. The status line indicates, for example, whether a traffic radio station has been activated, whether the heating and air conditioning system is operating in the circulating-air mode or the fresh-air mode, whether the activated carbon filter has been activated etc.

The first display area 210 which is in the form of a status line may contain a plurality of entries 1.1 to 1.5 which can and cannot be controlled and are inserted or removed depending on the system state. The ability to control some entries may make it possible to directly access important functions without rendering it necessary to change the application. If an entry in the status line is selected, this may directly lead to an associated function. For example, activating a letter symbol makes it possible to activate and open a display area in a ComTel application, i.e. in a communication or telephone application. Activating a telephone receiver symbol makes it possible to activate and open another display area in the ComTel application group. Activating a TP symbol deactivates a traffic program, i.e. a traffic radio station. In addition, various status displays which cannot be selected, such as a satellite dish for indicating GPS reception or a field strength, can be displayed.

The second display area 220 is in the form of an application line for displaying various application groups 2.1 to 2.5 which can be selected and prescribed, in particular a navigation (navi), an audio, a telephone/communication (Tel/Com), a video and a vehicle application group, the number and position of the entries to be displayed, i.e. of the application groups 2.1 to 2.5, being constant and the graphical representation of the entries to be displayed being able to be varied on the basis of an activated application group. Activating one of the application groups 2.1 to 2.5 which is not already active results in a changeover to the associated application and in activation of the fourth display area 240 for displaying functions and/or subfunctions associated with the activated application. If an application does not have functions and/or subfunctions, activating this application in the second display area 220 may activate the third display area 230 and display the control options associated with this application.

The arrangement of the application groups in the second display area 220 is constant and may be defined from left to right according to the frequency with which they are used and/or their importance. Selecting an application or application group results in at least one other display area being immediately activated and may be carried out by means of a manual input using the manual operating means 3 or by means of a voice input using the voice control means. The entries 2.1 to 2.5 in the application line 220 which have been marked using bold type are stored as keywords in the memory 6.4 of the voice control means 6 and are available to the voice recognition unit 6.1. Since none of the entries in one of the five display areas 210 to 250 has yet been activated, the entire screen corresponds, in FIG. 2, to the active display area.

The third display area 230 is in the form of an application area for displaying details of, and controlling, an application which has been selected and activated. The number and position as well as the graphical representation of the entries to be displayed depend on the activated application 2.1 to 2.5. The graphical representation of, and the ability to control, the third display area 230 can be varied and can therefore be effectively adapted to a highly varying functionality and to requirements imposed on the various applications 2.1 to 2.5.

The fourth display area 240 is in the form of a function line for displaying and selecting functions and/or subfunctions and/or options of an activated application 2.1 to 2.5. The number and position and graphical representation of the entries to be displayed, i.e. of the functions and/or subfunctions, depend on the activated application 2.1 to 2.5 and/or on the menu level. The graphical basic structure is constant over all menu levels of the menu structure.

The fifth display area 250 is in the form of a main application line. An application which can be preset can be displayed in this display area 250, The number and position of the entries 5.1 to 5.7 to be displayed are constant for the preset application, and the contents and the graphical representation of the entries 5.1 to 5.7 to be displayed can be varied and/or are constant depending on current system states. The preset application is preferably used to control an air conditioning system in the vehicle. The entry 5.1 (air conditioning) which can be selected and/or activated using a voice input is marked using bold type. The values indicated for a parameter which has been set, for example air temperature, strength of the fan etc., may vary. The current system states relate, in particular, to relevant states for controlling the temperature in the vehicle interior, for example outside temperature, solar radiation intensity, internal temperature, humidity etc.

FIG. 3 shows the screen display 2 on another menu level after the entry 2.1 (navi) in the second display area 220 has been selected and has been activated by pressing the manual operating means 3 or has been selected and activated by means of a voice input of the entry 2.1 “navigation”. Activating the entry 2.1 opens and activates the application menu (not illustrated) which is associated with the entry 2.1 and from which an entry “map display” has been selected. Activating the entry 2.1 “navi” displays the entries 4.1 to 4.3 in the function line, which are associated with the navigation application, in the fourth display area 240. In addition, activating the entry 2.1 “navi” and activating the map display opens a display area 230.1, which is associated with the map display, in the third display area 230. The display area 230.1 shows part of a road map.

Manually activating the entry “map display” (which is selected in the application menu), or activating the latter by means of a voice input, means that the screen display 2 which is illustrated in FIG. 3 and in which the “map display” application in the “navigation” application group is active with the settings which were set before the application was last left is reached. The entry 4.1 has been selected in the function line 240. The currently displayed entries 4.1 to 4.3 in the function line 240 are marked using bold type and may be opened if one of the functions is activated by appropriately selecting and activating the associated entry in the function line 240.

FIG. 4 shows an illustration of the screen display 2 on the same menu level as in FIG. 3, in which the entry 4.3 “destination” has been selected by means of a manual input using the manual operating means 3 or by means of a voice input. Selection of the entry 4.3 “destination” is indicated in FIG. 4 by means of the hatched illustration of the field containing the entry 4.3.

FIG. 5 shows an illustration of the screen display 2 on another menu level, in which the entry 4.3 “destination” in the function line has been activated by means of an appropriate input and a display area 240.1 which is associated with the entry 4.3 “destination” has been opened as a function menu, In the exemplary embodiment illustrated, the function menu is in the form of a vertical list having seven entries 240.1.1 to 240.1.7. The cursor marks the first entry 240.1.1 “address input” in this function menu. This is indicated by means of the hatched illustration of the associated field.

FIG. 6 shows an illustration of the screen display 2 on another menu level, in which the entry 240.1.1 “address input” in the function menu 240.1 has been activated by means of an appropriate input and a display area 240.2 which is associated with the entry 240.1.1 “address input” has been opened as a submenu. In the exemplary embodiment illustrated, the submenu is in the form of a vertical list having three entries 240.2.1 to 240.2.3. The cursor marks the first entry 240.2.1 “location” in this function menu. This is indicated by means of the hatched illustration of the associated field.

Inventive voice dialogs which are started by the voice control means 6 on the basis of the current menu level and/or the currently active display area are described below with reference to FIGS. 4 to 6.

If the voice control means 6 are activated on the menu level which is shown in FIG. 6 and has the activated display area 240.2, for example by operating the special PTT button (Push-To-Talk button) (not illustrated) or the manual operating means 3, the voice control means 6 start a first voice dialog and request the user, in a first dialog step, to input the name of the location, for example by means of a voice output: “Please say (or spell) the name of the location”. The intended control operation by the user can be discerned, with a high degree of probability, from the current cursor position within the menu structure (from the cursor position on the entry 240.2.1 “location” in this case), with the result that, in this connection, the voice dialog is directly initiated, according to the invention, by the voice control means 6. If, when activating the voice control means 6, the cursor is on the entry 240.2.2 “street”, for example, the voice control means 6 request a street name to be input. After the voice output, the voice control means 6 expect the requested voice input, for example the voice input of the name of the location or the street name, in a further dialog step. After the name of the location or the street name has been input by the user, the first inventive voice dialog is terminated and the user must reactivate the voice control means 6 for a new voice input.

If the voice control means 6 are activated on the menu level which is shown in FIG. 5 and has the activated display area 240.1, the voice control means 6 start a second voice dialog which, in a first dialog step, requests the user to select from a list which has been output, for example by means of a voice output: “Please select: input the address, name or special destination”. In a second dialog step, the voice control means 6 then expect one of the keywords “address”, “name” or “special destination”, which have been output, to be input without the user having to reactivate the voice control means. On the menu level illustrated and in the active display area 240.1, the current cursor position does not suggest any clear intended control operation by the user since a plurality of intended control operations are possible, namely inputting the destination using an address, a name or a special destination, with the result that the system outputs the possible voice commands to the user in the form of an audible list for selection.

In one refinement of the inventive control system, a further voice dialog comprises a sequence of first and second voice dialogs which build on one another and are carried out without renewed manual operation. If the user opts for the voice input “input name” in the second voice dialog described above, the user may be requested, for example in a further dialog step, to input the name of the desired destination under which the destination is stored in the memory 6.4, for example in an address book. In order to continue the voice dialog, the voice control means 6 may, in further dialog steps, request the user, after the name has been input, to render the input more precise, for example by means of the enquiry “Where do you wish to go: to the home or business address?” after the name “Müller” has been input. After the input has been rendered more precise by means of the voice input “home address”, navigation is then started. If the user opts to input the address by means of a voice input “input address”, the user reaches the menu level illustrated in FIG. 6 and the active display area 240.2. In the exemplary embodiment illustrated, for the cursor position shown in FIG. 6, the input of a street name may then be requested, by means of an appropriate voice output, in a further dialog step, after the name of the location has been requested and the user has effected the corresponding voice input, the user being able to input said street name, in a further dialog step, by means of an appropriate voice input of a street name. The user may then be requested, in a further dialog step, to input a house number by voice etc. The third voice dialog is terminated by the voice control means 6 when all of the dialog steps which build on one another have been executed. The voice control means 6 remain activated for the duration of the current voice dialog, with the result that the user does not have to carry out any further manual operation during such a voice dialog. Before a further voice input is requested, an enquiry as to whether the user wishes to effect a further voice input (which is provided for in the voice dialog) may first of all be output. The voice control means 6 may preferably output this enquiry in the form of a yes/no question. If a street name, for example, is provided as the next input, the voice output “Would you like to input a street name?” can be output and, in the case of a positive response, the input of a street name may then be requested.

While the inventive voice dialogs are being carried out, the representation of the menu structure on the screen display 2 is updated, in the exemplary embodiment illustrated, in accordance with the voice dialog steps. The representation of the screen display 2 shown in FIG. 5 thus changes to the representation shown in FIG. 6, for example, if the user selects the entry 240.1.1 “address input” in the voice dialog described above.

In order to be able to initiate the corresponding meaningful voice dialogs on the various menu levels, the voice control means 6 continuously determine the current menu level and/or the active display area 210 to 250 in the menu structure by, for example, requesting corresponding information from the evaluation and control unit 4.

In principle, the inventive voice dialogs can be used on all menu levels. However, the inventive voice dialogs are particularly suitable for inputting a destination to a navigation system or for controlling a telephone. Ambiguous terms which have been input, for example when inputting a destination to a navigation system if a plurality of destinations are possible with the name which has been input, for example Freiburg, or when selecting a name during telephone control if a plurality of entries exist for a name which has been input, for example Müller, or if a plurality of telephone numbers such as home, business or mobile exist, can then be rendered more precise in a plurality of voice dialogs which build on one another. In addition, when inputting a telephone number, inputting the digits, which are successively requested by the voice control means, in the form of a block is facilitated.

The embodiments described in connection with the drawings show that the invention can be used to control a wide variety of applications and/or functions. The inventive voice control means determine the intended control operation by the user on the basis of the current menu level and/or the active display area and/or the cursor position and, after they have been activated, start at least one voice dialog for selecting and/or activating one or more entries in the menu structure.

The inventive control system implements a standard control concept for voice control and manual control, which enables the user to control the menu structure having a plurality of menu levels using voice control means and/or the manual operating means without having to remember a voice command or having to read the possible voice commands from the screen display. As a result of it being possible to change between the input channels, i.e. between voice input and manual input, intuitive control and control convenience are improved. In addition, faster control is possible as a result of dialog steps being eliminated.

1-9. (canceled)

10. A control system for a vehicle, comprising:
a screen display having a plurality of display areas for displaying entries in a menu structure having a plurality of menu levels;
a manual operating means for selecting and/or activating at least one entry on a current menu level in the menu structure; and
a voice control means for redundantly selecting and/or activating at least one entry in the menu structure;
wherein the voice control means
evaluate the current menu level and/or an active display area and/or a current cursor position,
determine an intended control operation on the basis of the evaluation, and
after activation, start at least one voice dialog associated with the determined intended control operation, for selecting and/or activating one or more entries in the menu structure.

11. The control system as claimed in claim 10, wherein
the voice control means continuously determine the current menu level and/or the active display area in the menu structure.

12. The control system as claimed in claim 10, wherein
the voice control means, after activation, request a predetermined voice input in at least one dialog step in at least one first voice dialog if the voice control means detect a particular intended control operation.

13. The control system as claimed in claim 12, wherein
the voice control means listens for the predetermined voice input in at least one dialog step in the at least one first voice dialog.

14. The control system as claimed in claim 10, wherein
the voice control means, after activation, output possible keywords for selection in at least one dialog step in at least one second voice dialog if the voice control means detect a plurality of possible intended control operations.

15. The control system as claim in claim 14, wherein
the voice control means listens for at least one of the possible keywords in at least one dialog step in the at least one second voice dialog.

16. The control system as claimed in claim 10, wherein
the voice control means, after activation, start at least one third voice dialog comprising a sequence of voice dialogs which can be executed as a first and/or a second voice dialog.

17. The control system as claimed in claim 10, wherein
the voice control means remain activated for the duration of the at least one voice dialog.

18. The control system as claimed in claim 10, wherein
the representation of the menu structure on the screen display is updateable in accordance with the voice dialog steps.
